(19) United States
(12) Patent Application Publication
(10) Pub. No.: US 2007/0064324 A1
(43) Pub. Date: Mar. 22, 2007

(54) Discontinuous copying method and system

(75) Inventor: Mao-Yu Huang, Taoyuan (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Cyberlink Corp.

(21) Appl. No.: 11/229,887

(22) Filed: Sep. 19, 2005

(51) Int. Cl. G11B 5/86

(52) U.S. Cl. 360/15

(57) ABSTRACT

Digital data may be copied from a source device, or disc, to a target device, or disc, via an intermediary device, such as a hard drive. If the collective free storage space on all of the hard drive's partitions is sufficient to contain all of the contents of the source disc, a first portion of the content is saved on a plurality of the hard drive's partitions. The contents stored on the hard drive partitions are then written to a target disc and thereafter removed from or overwritten on the hard drive. Other portions of the source disc's contents may be saved to the hard drive in one or more partitions and then written to the target disc. This partial-copying of the source disc's contents may repeat until all of the source disc's files are copied to the target disc.

### TECHNICAL FIELD

This disclosure generally relates to optical disc generation, and more particularly, to a method and apparatus for using a plurality of hard drive partitions for creating copies of a source disc.

### BACKGROUND

With the advent of optical disc technologies, various media types have been utilized on such discs, including audio and video related data. As the capacities of such discs have increased, such as with CDs and even DVDs, an even increased amount of media content may be contained on even a single disc. Plus, as disc burning devices have become more commonplace in consumers' desktop and laptop computers, and similar devices, end users have experienced more freedom in being able to create their own media content and to make copies thereof.

However, with the expansion of popularity of disc burning applications, problems have arisen in regard to making copies of optical discs in certain situations. In one instance, in the case of large disc capacity burning, such as BD/HD DVDs or DVD DL discs, a computer may not have dual reading/writing optical drives or a hard drive large enough to store the contents of the disc

FIG. 1 is a diagram 10 of a laptop computer 12 configured with an optical disc device 16. In this nonlimiting example, the optical disc device 16 may be configured for reading and/or writing optical discs, such as CDs, DVDs, etc.

In this nonlimiting example of FIG. 1, a user desiring to make a copy of disc 18 on disc 20, which may be a DVD or similar type disc, as one of ordinary skill in the art would know, may not necessarily use laptop computer 12 for this application due to the fact that laptop computer 12 is equipped with a single optical disc device 16. Even though optical disc device 16 may be configured for both reading and writing operations, optical disc device 16 may perform one of those operations at a single time in this nonlimiting example due to the fact that laptop computer 12 has just one drive.

Solutions have arisen in response to the problem described above in regard to FIG. 1, wherein a hard drive 14 of laptop computer 12 may be used for storing a temporary copy of the contents on optical disc 18 during a reading operation. After the contents of optical disc 18 have been completely read and stored on hard drive 14, optical disc 20 may be inserted in its place in optical disc device 16 such that the contents stored on hard drive 14 may be copied to the blank disc 20. However, hard drive 14 may not have sufficient space in a single partition to maintain a data image during the disc copy process.

One of ordinary skill in the art would know that hard drive 14 may be configured in one or more partitions that are subdivided sizes of the entire optical disc 14 size. If the contents of optical disc 18, can fit into a single partition on hard drive 14, then the disc copy process of the contents from the single partition of hard drive 14 to optical disc 20 may transpire, as one of ordinary skill in the art would know. However, as stated above, the capacities of optical discs, such as DVDs, are increasing such that hard drive partitions may not be large enough to store the entire contents of an optical disc. Plus, as optical discs continue to expand in their capacity, it is envisioned that this problem will continue to outpace the increased storage capacity of hard drive media, as may be partitioned.

Additionally, situations may exist wherein a user's hard drive is not sufficiently large enough to store the entire contents of a optical disc 18. Thus, even in the instances described above, the hard drive can not contain the entire contents of optical disc 18 because it has insufficient available storage space, which as a nonlimiting example may be a high capacity DVD media.

Furthermore, during copy operations, a user may desire to temporarily suspend or disable the copy process. As a nonlimiting example, if battery of the user's laptop, computer 12 expires, or the user otherwise needs to utilize the laptop computer 12 for another purpose, the copy operation of optical disc 18 must be halted in the middle of the process.

Thus, there is a heretofore unaddressed need to overcome the deficiencies and shortcomings described above.

### SUMMARY

Digital data may be copied from a source device, or disc, to a target device, or disc, via an intermediary device, such as a hard drive. If the collective free storage space on all of the hard drive's partitions is sufficient to contain all of the contents of the source disc, a first portion of the content is saved on a plurality of the hard drive's partitions. The contents stored on the hard drive partitions are then written to a target disc and thereafter removed from the hard drive. Other portions of the source disc's contents may be saved to the hard drive in one or more partitions and then written to the target disc: This partial-copying of the source disc's contents may repeat until all of the source disc's files are copied to the target disc.

As data files are copied from the source disc to the hard drive, a directory file is established on the hard drive. The directory file may be a meta file, as a nonlimiting example, that contains information corresponding to logical locations of the content copied from the source disc, as stored on the hard drive, including the plurality of partitions.

As contents of the source disc are saved to the hard drive, source context information may be created and stored on the hard drive related to a reading range on the source disc and a next reading range on the source disc. This source context information enables the process to return to the precise position where copying of source disc content previously ended. Likewise, target context information may be created related to status information for the target disc, a writing range for the target disc, and a next writing range for the target disc. This target context information enables the process to resume writing operations on the target disc where prior writing operations ended.

Other systems, methods, features, and advantages of the present disclosure will be or become apparent to one with skill in the art upon examination of the following drawings and detailed description. It is intended that all such additional systems, methods, features, and advantages be included within this description, be within the scope of the disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 is a diagram of a laptop computer having a single optical disc reading and writing device.

FIGS. 2 and 3 are flowchart diagrams depicting a process for copying data from a source disc onto a plurality of hard drive partitions and further onto a target drive that may be placed in the optical disc device of FIG. 1.

FIGS. 4-8 are graphical illustrations of the disc save and copy process described in FIGS. 2 and 3.

FIG. 9 is a diagram of a configuration coupling laptop computer of FIG. 1. to a video camera 94.

FIG. 10 is a flowchart diagram of a process for burning data on a device such as video camera of FIG. 9 onto a hard drive or target disc.

FIG. 11 is a flowchart diagram of a process for copying the contents on the source disc of FIG. 1 onto the target disc of FIG. 1 in a discontinuous format.

FIGS. 12-18 are graphical illustrations of the process of FIG. 11.

### DETAILED DESCRIPTION

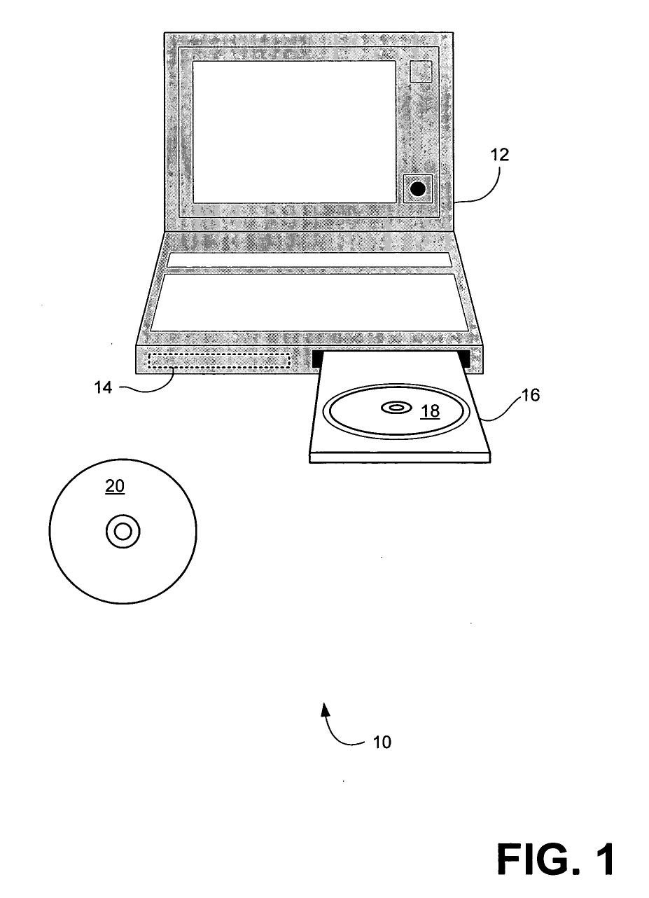

Returning to the diagram 10 of FIG. 1, if laptop computer 10 is coupled either internally or externally to an additional optical disc reading/writing device (not shown), then the contents of optical disc 18 may be copied directly to optical disc 20 from optical disc device 16. In this instance, a copy can be made without involving the hard drive, as described above. However, the configuration shown in FIG. 1 is common at least in applications involving portable computing devices and other applications wherein the laptop computer 12 or other computing device is configured with a single optical disc drive 16.

As disclosed herein, a process may be implemented such that a source disc 18 is read by optical disc device 16 and its contents stored in two or more partitions of the hard drive 14 that collectively has sufficient space to store the contents of the source disc 18, but not in any single partition. Upon storing the contents of the source disc 18 onto the multiple partitions of the hard drive 14, a target disc 20 may be inserted into optical disc device 16 such that the copied data on the various partitions of hard drive 14 is further sequentially or randomly copied to target disc 20. As described in more detail below, the process may be implemented such that the content on source disc 18 may be divided across various partitions of the hard drive 14 and thereafter saved and essentially reconstructed into the original format on the target disc as an identical form as on the source disc 18.

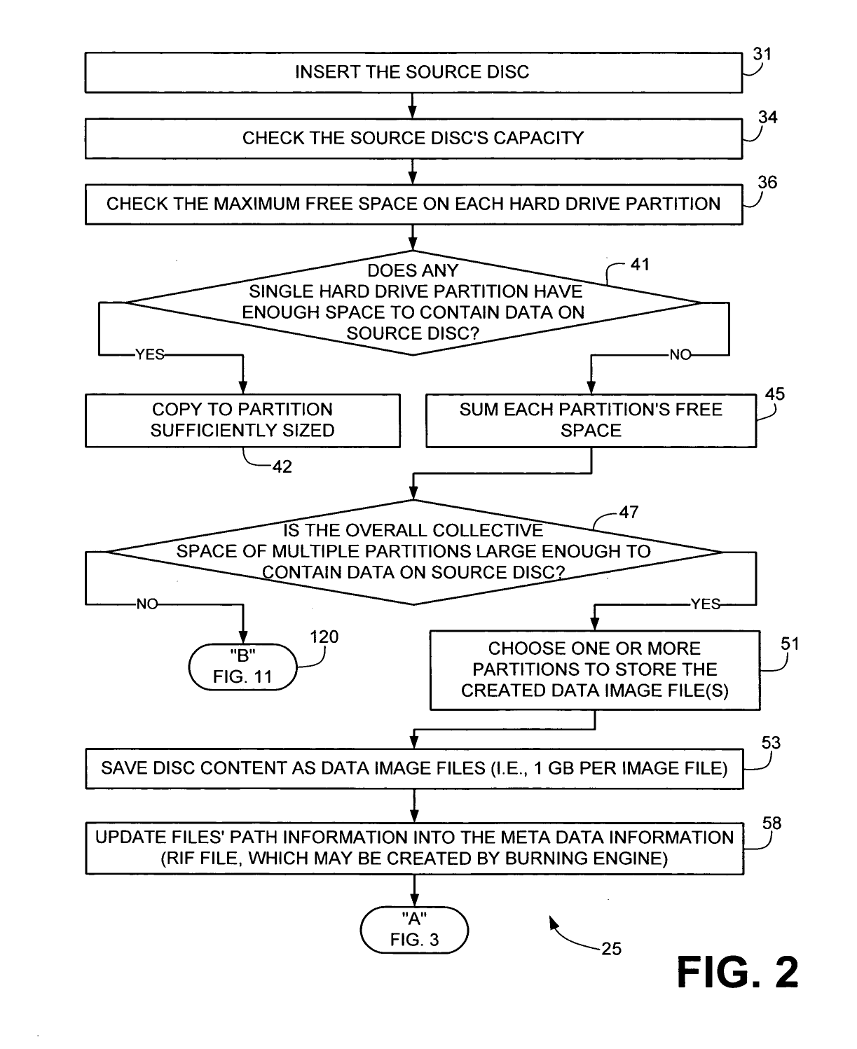

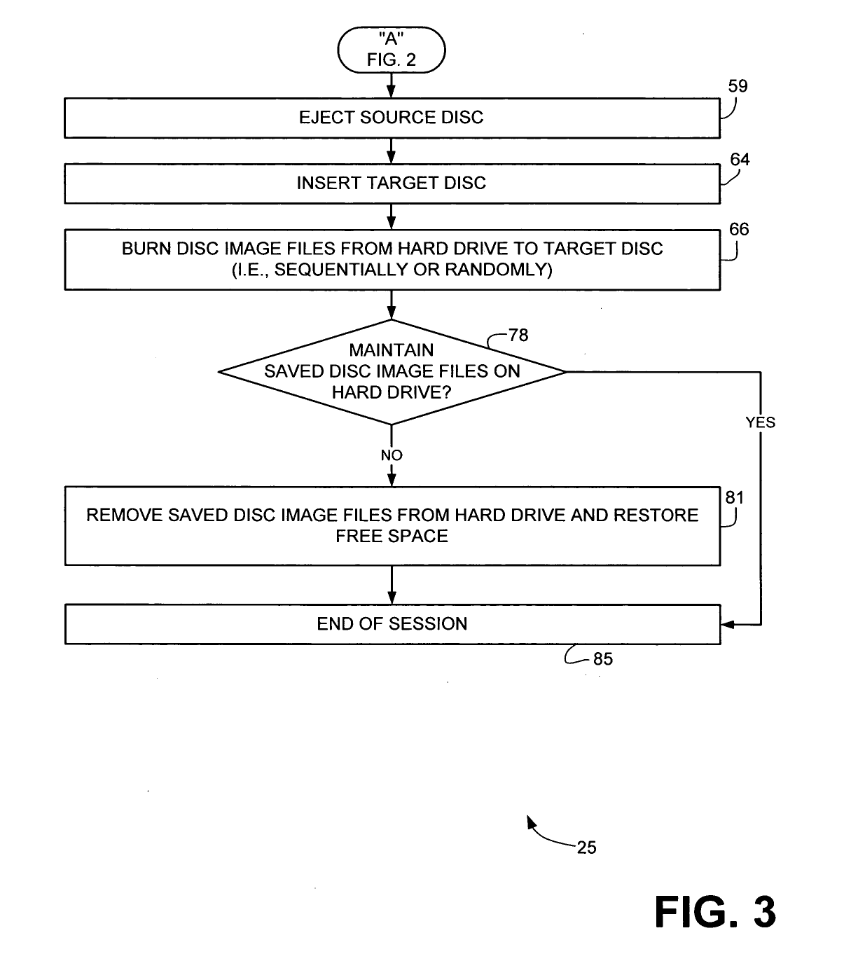

FIGS. 2 and 3 are flowchart diagrams 25 depicting a process for copying data from a source disc 18 onto a plurality of hard drive 14 partitions and further onto a target drive that may be placed in optical drive 16 of FIG. 1. In the process 25 of FIG. 2, a source disc may be inserted into the optical disc device 16, as shown in step 31. The optical disc device 16 may be configured to check the source disc's capacity, as in step 34. In initiating the copy sequence, the laptop computer 12 or other computing device, may thereafter check the available/maximum free space on at least two hard drive partitions, as shown in step 36.

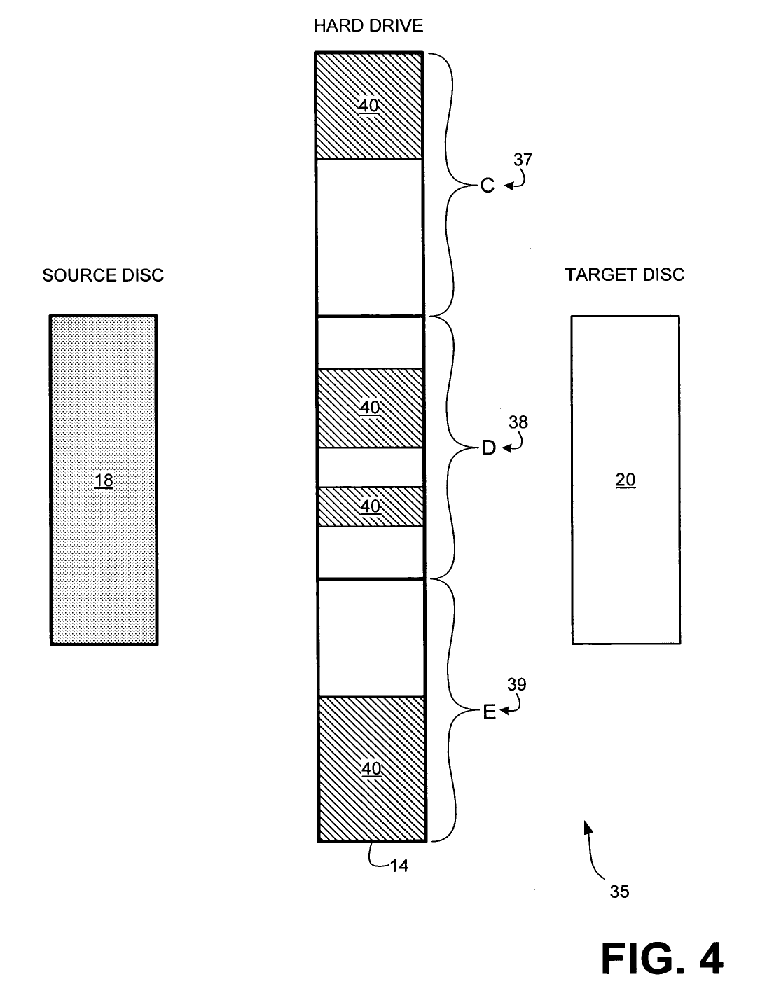

FIGS. 4-8 are graphical illustrations 35 of the disc save and copy process described and depicted in FIGS. 2 and 3, and are described in conjunction with FIGS. 2 and 3. In FIGS. 4-8, hard drive 14, source disc 18, and target disc 20 are depicted as columns to show free and occupied storage space. In FIG. 4, hard drive 14 may include, as a nonlimiting example, three partitions. In this nonlimiting example, hard drive 14 may include partition C, denoted as reference number 37, partition D as reference number 38, and partition E, denoted as reference number 39. In this nonlimiting example, hard drive 14 contains previously saved data 40 in the three partitions C, D, and E. Consequently, in executing step 36 of FIG. 2, the process checks the available/maximum free space on at least two hard drive partitions.

Thereafter, the laptop computer 12 may be configured to determine, as in step 41 of FIG. 2, whether a single hard drive partition has enough space to contain all of the data on source disc 18. In this nonlimiting example, as shown in FIG. 4, the partitions C, D, and E may be checked to determine whether previously saved data 40 in each such partition has consumed too much of the available storage space such that the complete contents of source disc 18 cannot be saved in a single partition C, D, or E. Although the nonlimiting example of FIG. 4 suggests otherwise, if the process determines that a single partition does indeed contain enough storage space to receive the contents of source disc 18, the process may move to step 42 and copy all of the contents of source disc 18 onto a single partition. However, as shown in illustration 35 of FIG. 4, no partition C, D, or E has enough individual free storage space in order to contain the contents of source disc 18, which is graphically represented as being larger than any available space of a partition C, D, or E in this nonlimiting example.

Thereafter, the process 25 of FIG. 2 moves to step 45, resulting in the summation of each partition's free space. As shown in the graphical illustration 35 of FIG. 4, the nonhatched areas of hard drive 14 collectively may be sufficiently large to store the contents of source disc 18. Thus, in step 47 of FIG. 2, the process determines whether the overall collective space of the multiple partitions C, D, and E is large enough to contain all of the data on source disc 18.

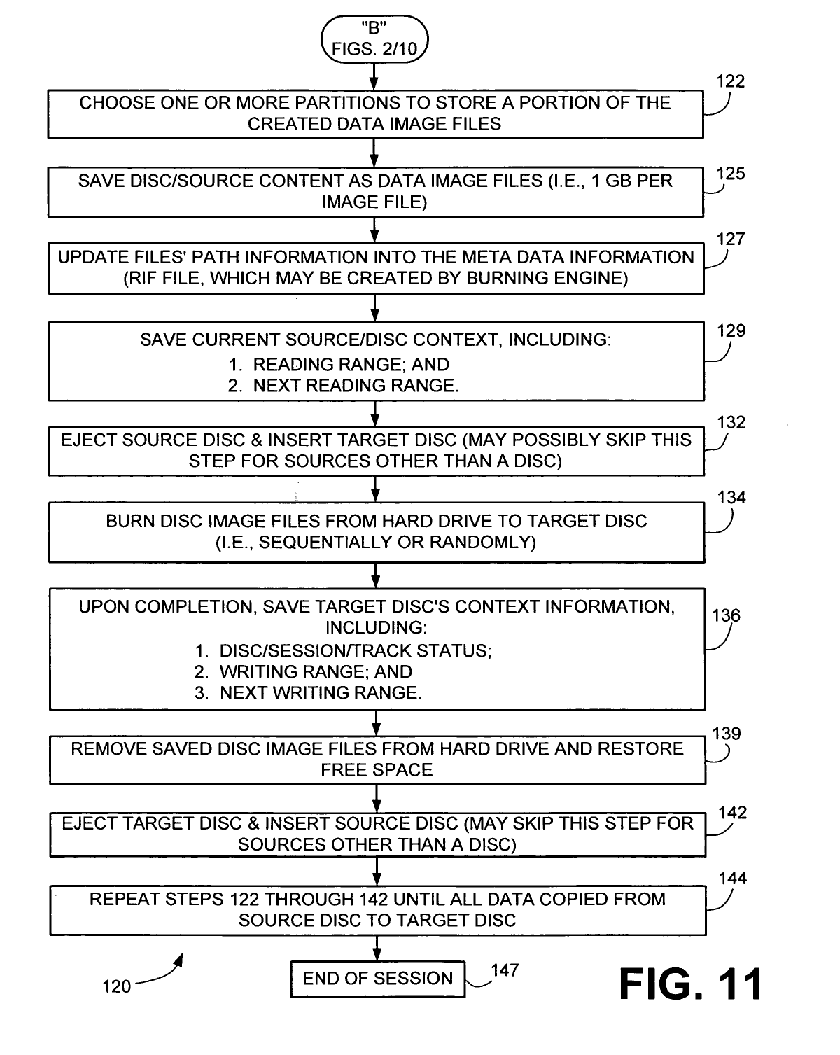

In this nonlimiting example, the available free space of partitions C, D, and E, is large enough in the aggregate to contain the contents of source disc 18. If the result of step 47 is that partitions C, D, and E do not have enough space to store the contents of source disc 18, the process moves to step 120, which is described in FIG. 11. However, in this nonlimiting example of FIG. 4, available space exists to store the contents of source disc 18 across multiple partitions C, D, and E.

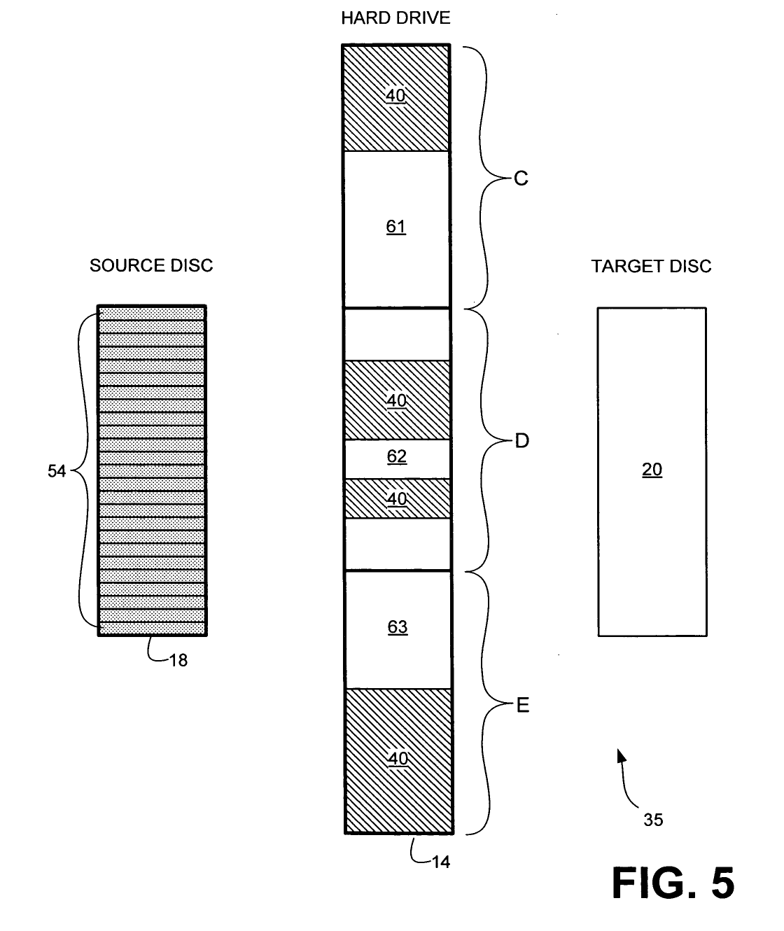

The process 25 may choose, as shown in step 51 of FIG. 2, one or more areas within the multiple partitions to store the data image files of source disc 18. In this nonlimiting example, the process may choose available storage space 61 in partition C, 62 in partition D, and 62 in partition E, all of FIG. 5. One of ordinary skill in the art would know that various methodologies could be implemented for selecting various free space sections within the various partitions of hard drive 14, such as largest to smallest, etc.

In preparing to store the contents of source disc 18 to the available storage spaces 61, 62, and 63 across the various partitions C, D, and E of hard drive 14, the process 25 may save one or more image files 54 of the contents of source disc 18. As a nonlimiting example, the contents of source disc 18 may be divided into one-gigabyte image files for storage onto hard drive 14. In this nonlimiting example, if source disc 18 contains 25 gigabytes of data, step 53 (FIG. 2) divides the contents of source disc 18 in to 25 1-gigabyte image files for storage onto hard drive 14.

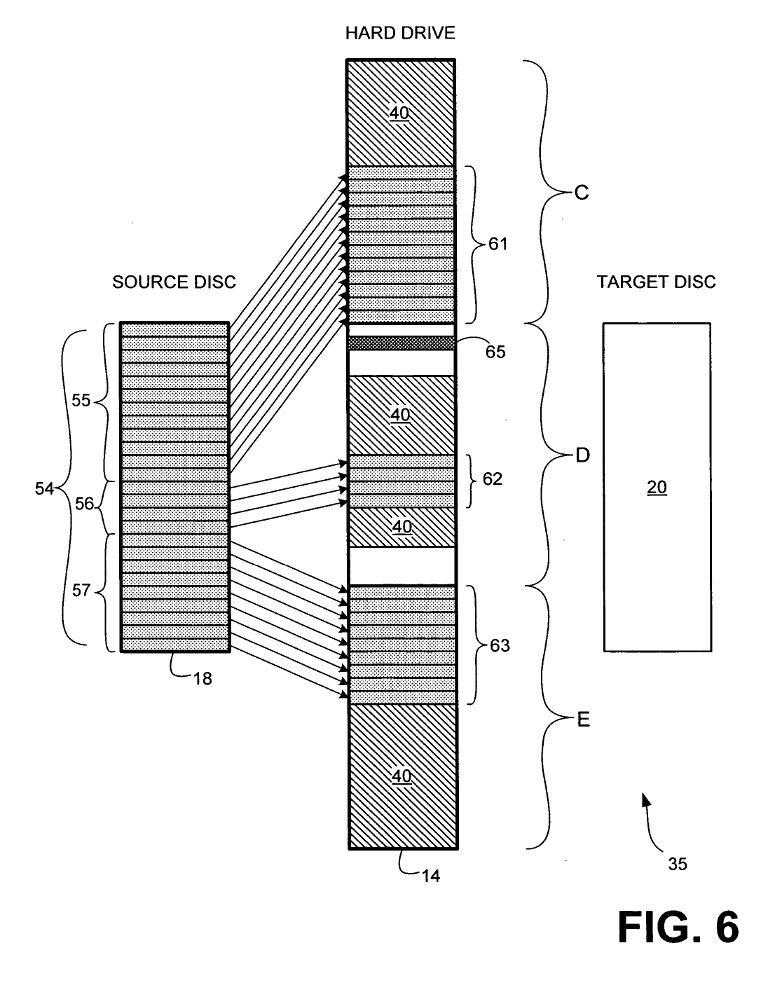

FIG. 6 is a continued diagram of the graphically-illustrated process 35 that is also depicted in flowchart format in FIGS. 2 and 3. FIG. 6 depicts the saving of the image files 54 on source disc 18 onto the various partitions C, D, and E of hard drive 14. In this nonlimiting example, the first 12 1-gigabyte image files 55 may be copied onto partition C at storage position 61. Likewise, the next four 1-gigabyte image files 56 may be copied onto available storage space 62 of partition D. Finally, the remaining nine 1-gigabyte image files 57 of source disc 18 may be copied to storage position 63 in partition E, as shown in FIG. 6. Thus, the 25 1-gigabyte image files are stored across three partitions in C, D, and E in different logical locations.

Returning to step 58 of FIG. 2, the file paths of each of the 25 1-gigabyte image files are updated in a single data file that is also stored on hard drive 14. As a nonlimiting example, a recording image file (RIF) may be created that is the meta data information 65 containing all of the file paths for each of the 25 image files originally contained on source disc 18 and copied to hard drive 14. This meta data information 65 may essentially describe the 25 separate image files so that the entire contents of the original source disc 18 content is maintained on hard drive 14. This meta data information 65 can be saved as an independent file, as shown in the nonlimiting example of FIG. 6, or the meta data information 65 may be embedded in one of the image files, such as the first or the last image file (not shown in FIG. 6).

At this point, the contents of source disc 18 may be completely saved onto the multiple partitions of hard drive 14 such that the process goes no further. Stated another way, implementations may exist where a user of this process desires to merely copy the contents of source disc 18 onto a hard drive 14 for further manipulation and/or playback on the laptop computer 12 or another coupled device. As a nonlimiting example, DVD content that may be copied from source disc 18 onto hard drive 14 may be saved on hard drive 14 for editing and other manipulation and/or playback on laptop computer 12. Nevertheless, hard drive 14 contains an identical copy of the image file information of source disc 18 spread across the three partitions C, D, and E of the hard drive 14. So, to this point, the process of FIG. 2 depicts a disc copy and save process.

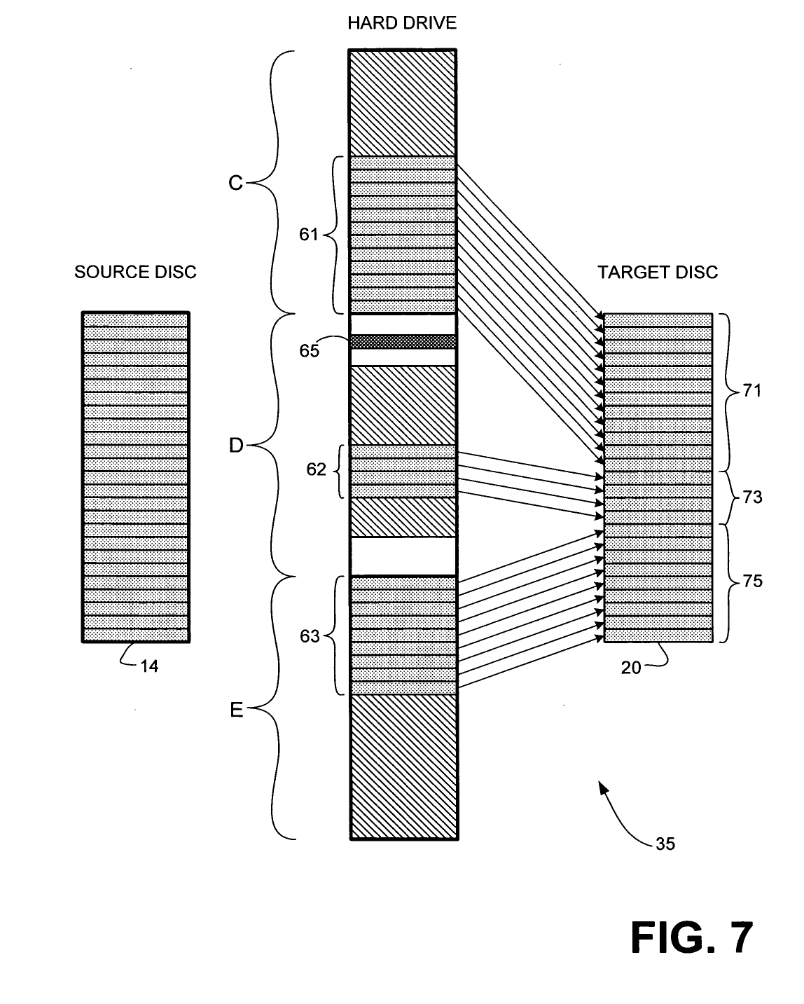

However, continuing on to FIGS. 3 and 7, respectively, applications may exist wherein a user of this process desires to further copy the contents stored on hard drive 14 onto a target disc 20, which may be a blank disc in one nonlimiting example. In step 59 of FIG. 3, the source disc may thereafter be ejected from optical disc device 16 so that target disc 20 may be inserted, as in step 64. The process continues in step 66 of FIG. 3 such that the image files stored on hard drive 14 at storage locations 61, 62, and 63 (FIG. 7) are sequentially or randomly burned onto target disc 20 from hard drive 14 and its multiple partitions in the order in which the files were copied onto hard drive 14. More particularly, at least in one nonlimiting example, the 1-gigabyte image files in partition C at position 61 may be first written onto target disc 20, as shown in FIG. 7. More particularly, these image files 61 may be written, or burned, into positions 71 on target disc 20.

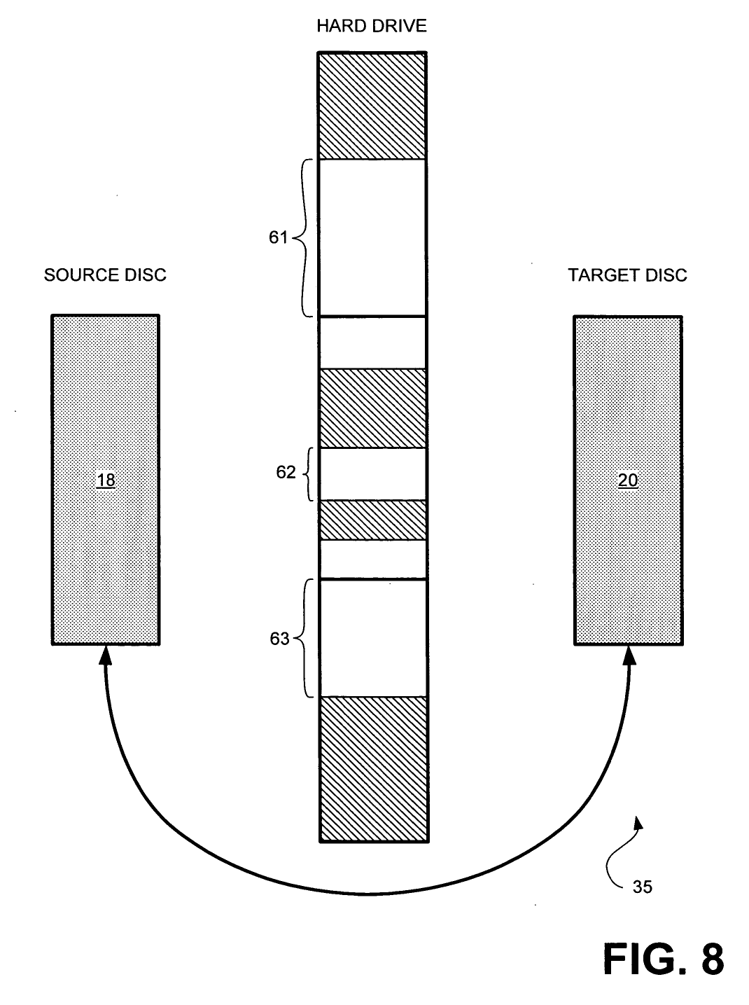

The saved image files stored on hard drive 14 at storage position 62 in partition D may be written thereafter into position 73 on target disc 20. Finally, the saved image files on partition E at storage position 63 may be burned or written on to target disc 20 at position 75. As stated above, it should be noted that each of the saved data image files at storage locations 61, 62, and 63 are burned onto target disc 20 sequentially or randomly in the order in which they were written on to the various partitions of hard drive 14 so as to maintain a proper order and sequence on target disc 20. After all of the image files are copied from the hard drive 14 to the target disc 20, as shown in FIG. 8, target disc 20 is an identical copy of source disc 18.

In returning to step 78 of FIG. 3, a determination may be made whether to save the image files stored on hard drive 14 at locations 61-63. If a user opts to maintain a copy of the source disc 18 image files on both target disc 20 and hard drive 14, the process 25 of FIG. 3 moves to step 85 and ends the copy session. However, if the user opts to remove the saved image files in positions 61-63 on partitions C, D, and E of hard drive 14 to free up the storage space, step 81 of FIG. 3 is implemented. In step 81, the saved data image files are deleted from hard drive 14 such that the free storage space in each partition C, D, and E is restored, as shown in FIGS. 4 and 8. Thus, this “not-on-the-fly” disc copy process 25 of FIGS. 2 and 3 thereafter ends at step 85.

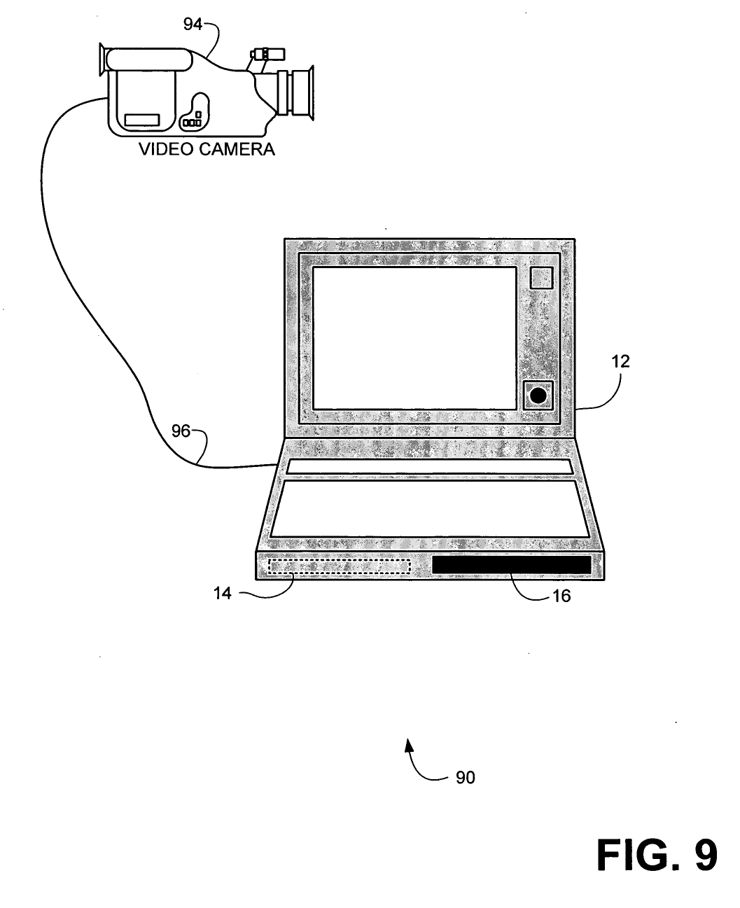

Instead of merely copying from one disc on laptop computer 12, or other computing device, onto another, as described above, a user may seek to copy source content from a device other than a disc. FIG. 9 is a diagram 90 of a configuration coupling laptop computer 12 of FIG. 1. to a video camera 94. One of ordinary skill in the art would know that video camera 94 in this nonlimiting example may be any type of coupled device that stores data that may be electronically communicated to laptop computer 12 via coupling 96 (or wirelessly as well).

In this nonlimiting example of FIG. 9, video camera 94 may contain a DVD or other tape storage device containing video data recorded by video camera 94. However, other nonlimiting examples of devices that may be substituted for video camera 94 include audio recorders, MP3 players, other network computers, and virtually any other device that may be networked or coupled to laptop computer 12 (which may be any type of similar device) locally or remotely, as one of ordinary skill in the art would know. Nevertheless, in this implementation 90 of FIG. 9, a user may desire to move data on video camera 94 onto either hard drive 14 or even a target disc 20 that may be inserted into optical disc device 16.

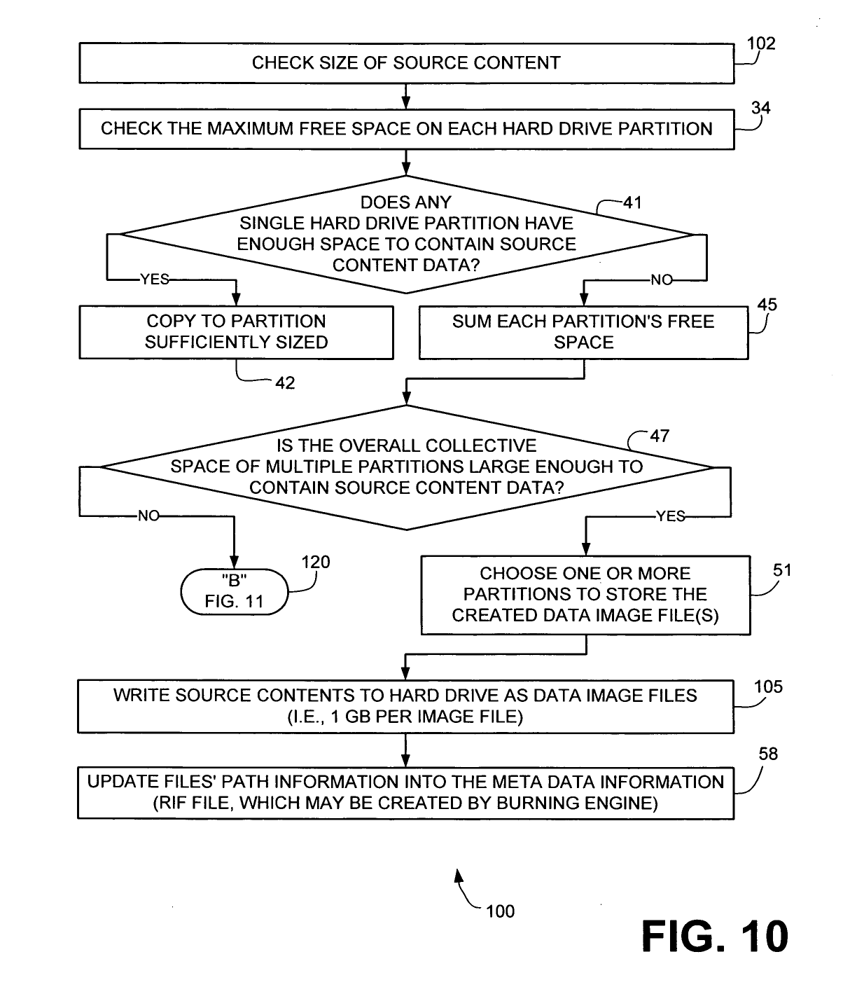

FIG. 10 is a flowchart diagram 100 of a process for burning data on a device, such as video camera 94 of FIG. 9, onto a hard drive 14 or target disc 20, as described above. For purposes of simplicity, steps that are similar as described above in FIG. 2 are described with the same reference numeral of FIG. 2; however, steps that are different in this process 100 are provided with a new reference numeral for clarity.

In step 102 of FIG. 10, the process 100 checks the size of the source content. In this nonlimiting example, laptop computer 12 may determine the size of the data files contained on video camera 94 to determine if direct copying may be made onto a single partition C, D, or E of hard drive 14 or target disc 20, as may be desired by the user. However, once the size of the source content is determined in step 102, steps 34, 41, 42, 45, 47, 51, and 120 of FIG. 10, as described above in regard to FIG. 2, are implemented in preparation to store the source content on video camera 94 onto hard drive 14 of laptop computer 12 (or other computing device).

In step 105, the process thereafter writes the source contents from video camera 94 (or other similar device, as described above) onto the various partitions of hard drive 14, as data image files. As similarly described above, the data image files may be configured as 1-gigabyte image files that may be written onto the various partitions of hard drive 14, as described above. Thereafter, in step 58, the file paths of the various image files are maintained in a recording image file so that the location of each image file is known and available for further manipulation writing and/or use.

In this way, a user may create copies of source content that may be stored on an optical disc or another electronic device onto a target device that may either be another optical disc or a hard drive by utilizing a plurality of partitions on the hard drive as either a temporary or even a permanent file storage location. Thus, for users who have laptops or only a single burning device, a single disc reading/writing device, creating copies of such content may still be realized.

In the nonlimiting examples described above, a determination was made in step 47 of FIG. 2, that hard drive 14, had sufficient space on the collective partitions to contain all of the image data files on source disc 18. However, if the result of the determination 47 in FIG. 2 is a negative result, which means that the hard drive 14 does not have sufficient space for all of the contents of source disc 18, step 120 of FIG. 2 is executed, which is depicted in FIG. 11.

FIG. 11 is a flowchart diagram 120 of a process for copying the contents of source disc 18 of FIG. 1 onto a target disc 20 of FIG. 1 involving inserting and ejecting the source and target disc inter-changeably and repeatedly until all files are copied. In step 122, the process 120 operates to choose one or more partitions for storing at least a portion of the saved data image files on source disc 18. In this nonlimiting example, if it is determined that hard drive 14 cannot contain all of the saved data image files on source disc 18, then at least a portion will be copied onto hard drive 14 in this first pass. In step 125, a portion of the source files source disc 18 are saved as data image files, which may be in 1-gigabyte increments, as described above. As also described above, step 127 provides that the file path for each data image file saved in step 125 is maintained in a recording image file on hard drive 14.

At this point when the hard drive 14 has been filled to capacity or to a predetermined point with data image files from the source disc 18 in this nonlimiting example, step 129 provides that a current context for the source disc 18 is saved on the hard drive 14. The context saved, as shown in step 129, may include the reading range and the next reading range of source disc 18 so that the copying process may resume where interrupted at the point where hard drive 14 was completely filled.

In step 132, the source disc 18 may be ejected from laptop computer 12 so that target disc 20 may be inserted into optical disc drive 16. Thereafter, in step 134, as also described above, the data image files may be subsequently burned, or copied, from the hard drive 14 to the target disc so as to create a copy of those data image files copied from source disc 18 onto target disc 20. Alternatively, step 132 may be skipped if the source content being copied is not on a disc but is otherwise contained in a media that does not utilize optical drive 16. As a nonlimiting example, source content may be contained on video camera 94 of FIG. 9. In this instance, target disc 20 may be placed into optical disc drive 16 for the duration of the copy process.

Upon completion of step 134, step 136 provides that the target disc context information is saved on hard drive 14. The target disc 20 context information may include the disc/session/track status; the writing range of target disc 20; and the next writing range on target disc 20. This context information saved in step 136 enables the resumed writing or burning operations at the precise point where the previous operations ended so that the sequential nature of the copy process is not interrupted.

In step 139, the saved data image files on hard drive 14 are erased so as to create free storage space on hard drive 14 on the various partitions C, D, and E for receiving additional data image files from source disc 18 that could not be copied in the previous operation. After step 139, step 142 provides that the target disc 20 is ejected from optical disc device 16 so that source disc 18 may be reinserted to copy the remaining or at least another portion of the image files on source disc 18. However, as with step 132, target disc 20 may be placed within optical disc device 16 throughout process 120 if the source content being copied is not on an optical disc.

In step 144, steps 122-144 as described above are repeated until all the data on source disc 18 is copied onto hard drive 14 and subsequently onto target disc 20. Upon completion of step 144, target disc 20 should be an identical copy of source disc 18. Thereafter, the copy session described herein includes, as shown in step 147.

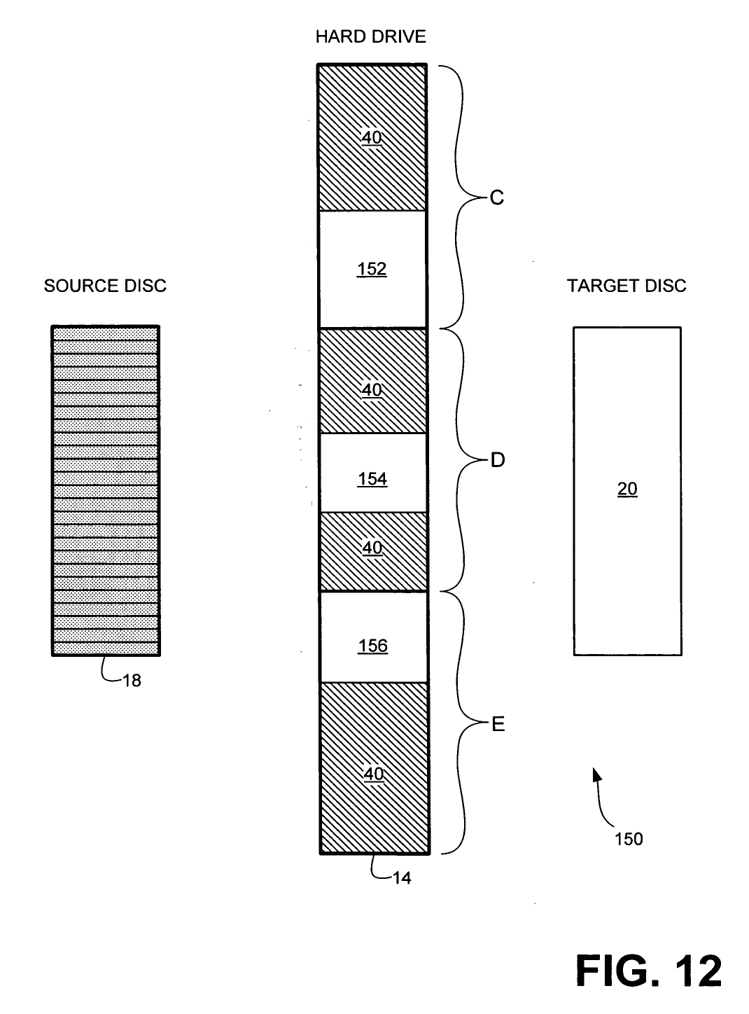

FIGS. 12-18 are graphical illustrations 150 depicting the flow chart process 120 of FIG. 11 or copying data from a source disc 18 to a target disc 20. In this nonlimiting example, 150 of FIG. 12, the previously stored data 40 in each partition, C, D and E occupy a greater portion of the hard drive 14 in this nonlimiting example than as in the nonlimiting example 35 of FIG. 4. Consequently, it is apparent that the available storage areas 152 in partition C, 154 in partition D, and 156 in partition E collectively is smaller than the graphically represented source content on source disc 18.

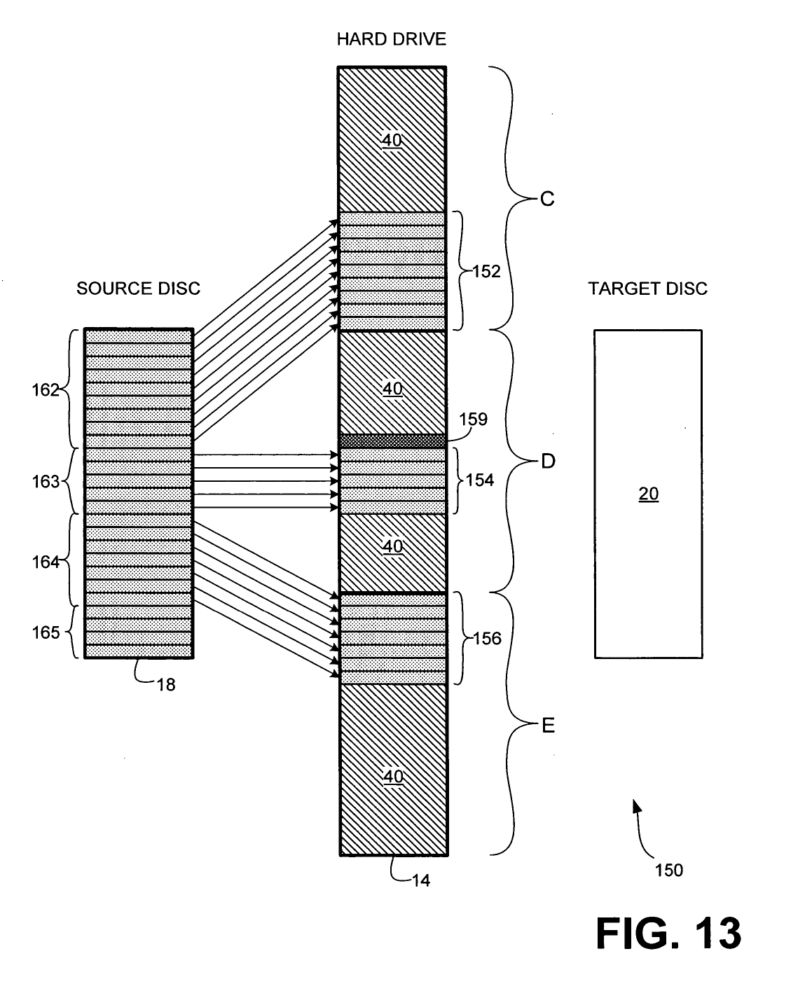

Thus, in FIG. 13, at least a portion of the contents of source disc 18 may be copied to the available storage locations 152, 154, and 156. More specifically, data image files 162 on source disc 18 may be copied to storage location 152 in partition C of hard drive 14. Furthermore, the data image files 163 on source disc 18 may be copied to storage location 154 in partition D of hard drive 14. Further, data image files 164 on source disc 18 may be copied to storage location 156 of partition E. As is apparent in FIG. 13, not all the data image files on source disc 18 may be copied to hard drive 14 in this instance due to the fact that hard drive 14 contains no additional available memory space. Thus, data image files 165 on source disc 18 may not be copied at this stage in the process.

As described above, the meta data information 159 may be established essentially addressing each of the data image files in each of the partitions C, D and E of hard drive 14. This meta data information 159 enables the hard drive 14 to essentially link all of the data image files together if the user were to attempt to utilize those image files off of hard drive 14 or for further recording operation as described herein. The meta data information 159 may be saved as an independent file, as shown in the nonlimiting example of FIG. 13. Alternatively, the information 159 may be embedded in one of the image files, such as the first or the last image file (not shown in FIG. 13).

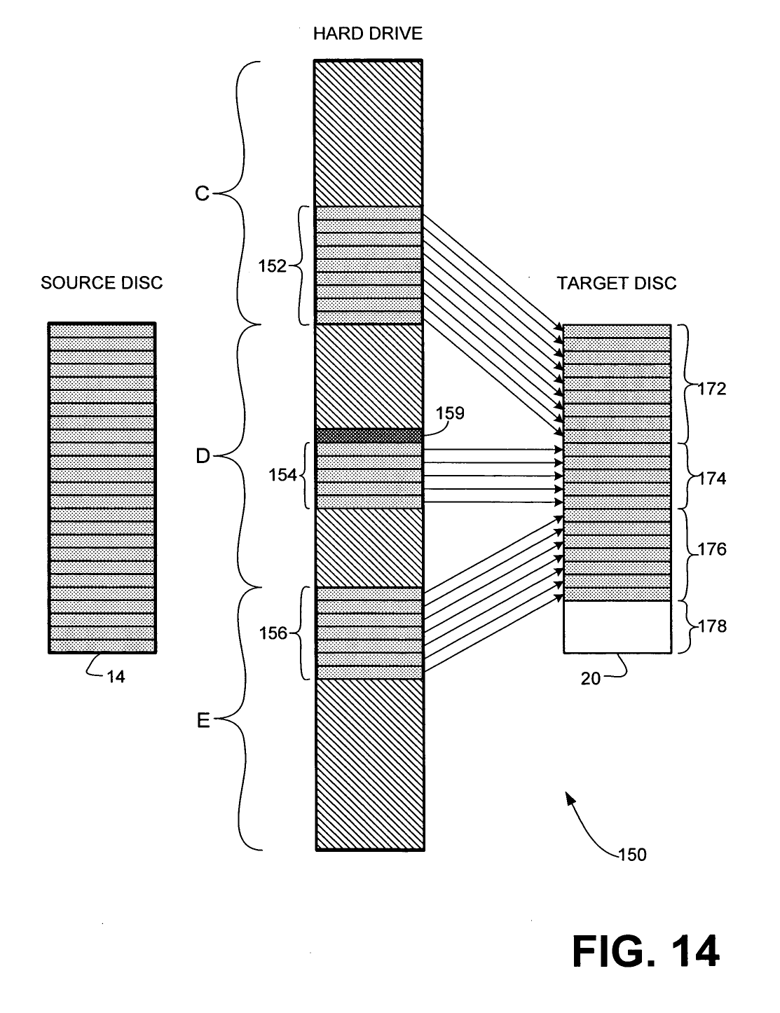

FIG. 14 depicts process 150 wherein the data image files stored on hard drive 14 at locations 152, 154, and 156 are copied onto target disc 20. Specifically, the data image files at storage location 152 may be copied sequentially or randomly onto target disc 20 at receiving location 172. Furthermore, the data image files at storage location 154 may be copied onto target disc 20 at receiving location 174 which is sequentially or randomly after the receiving location 172. Finally, the data image files at storage location 156 may be copied to receiving location 176 on target disc 20 which is sequentially or randomly after receiving location 174. In this way, each of the data image files copied from source disc 18 to hard drive 14 in this portion of the process are now copied completely over to target disc 20. Nevertheless, at least a portion 178 of target disc 20 remains as available free space due to the fact that hard drive 14 could not contain all of the data image files off of source disc 18 in this nonlimiting example.

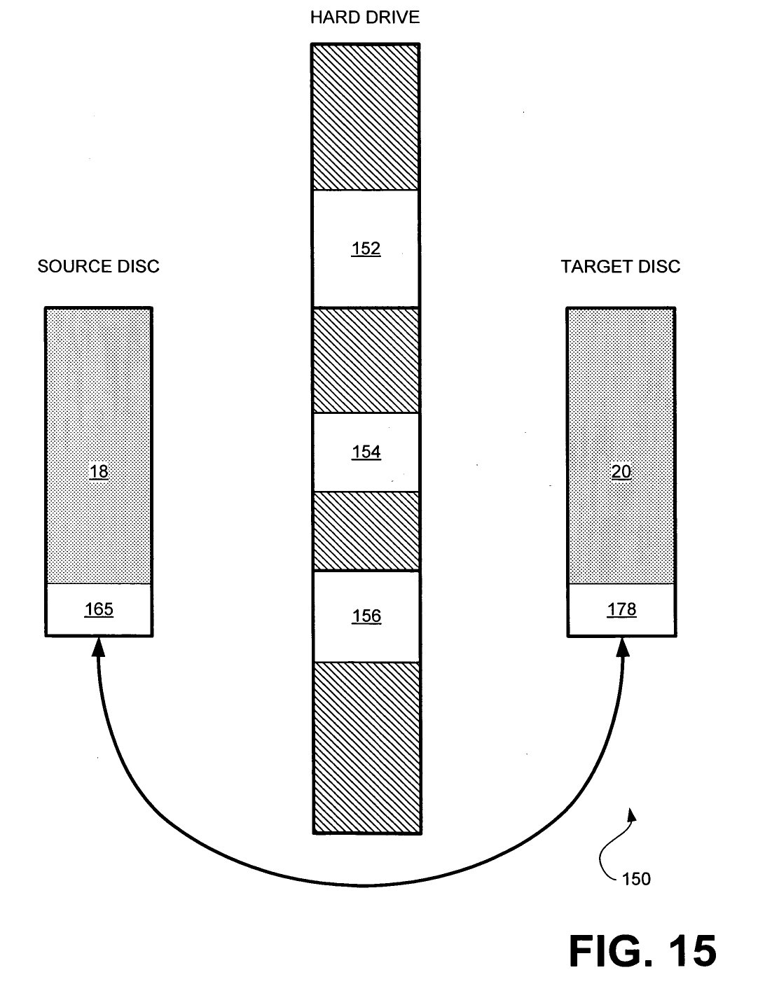

FIG. 15 graphically illustrates a situation wherein at least a portion of the data image files are not copied in this first copy process. More specifically, the data image files 165 on target disc 18 were not copied in the first copy process, which corresponds to the available free space 178 on target disc 20 in this nonlimiting example. However, the data image files at each storage locations 152, 154, and 156 may be removed as shown in FIG. 15 so as to make room for the data image files 165 on source disc 18 in the next portion of the copy process.

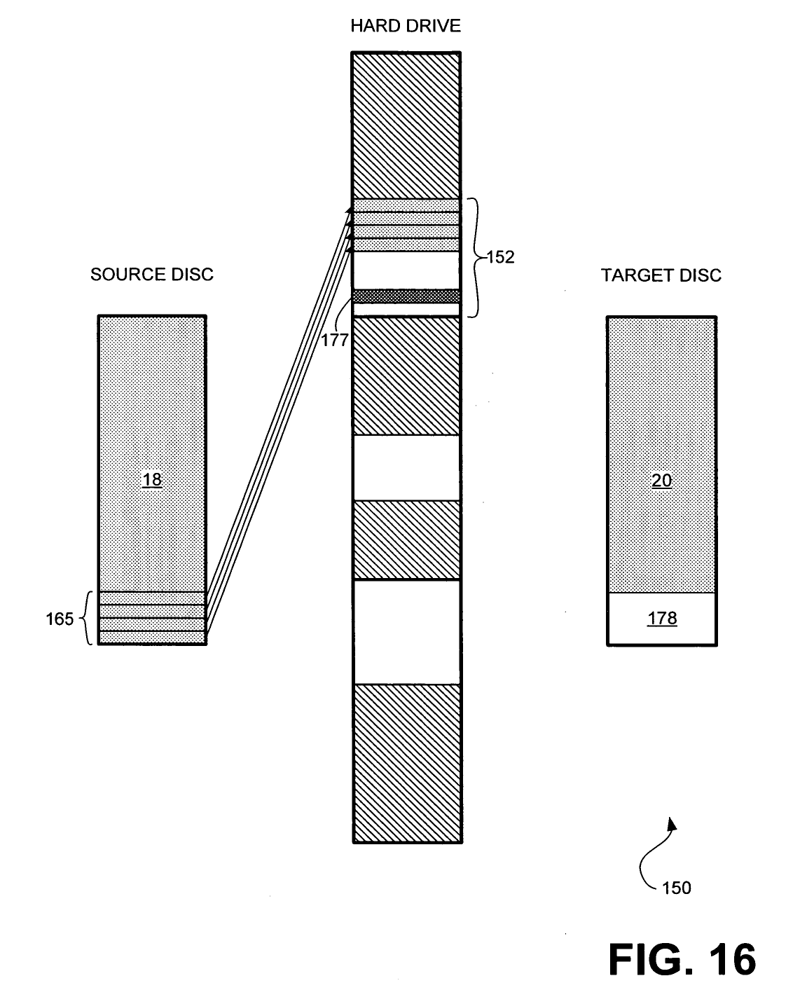

FIG. 16 is a diagram of the second stage (or resumed stage) of the copy process wherein the data image files 165 on source disc 18 are copied to storage location 152 on hard drive 14. It should be noted that this second or resumed stage may be executed immediately after the first stage described above or subsequently in time. As a nonlimiting example, if a user needs to divert attention to other tasks, or if the laptop computer 12 loses power (i.e., if the battery nears exhaustion), the second stage may be accomplished at a later time.

Nevertheless, as described above in regard to FIG. 11, step 29 provides that the reading range is retained in memory in hard drive 14 so that the copy process can presume precisely with data image files 165 on source disc 18 and not in any of the previous copied files in the first stage of the process described above. As also described above, meta data information 177 may be established as a stand-alone file, as shown in FIG. 16, or as part of one of data image files 165.

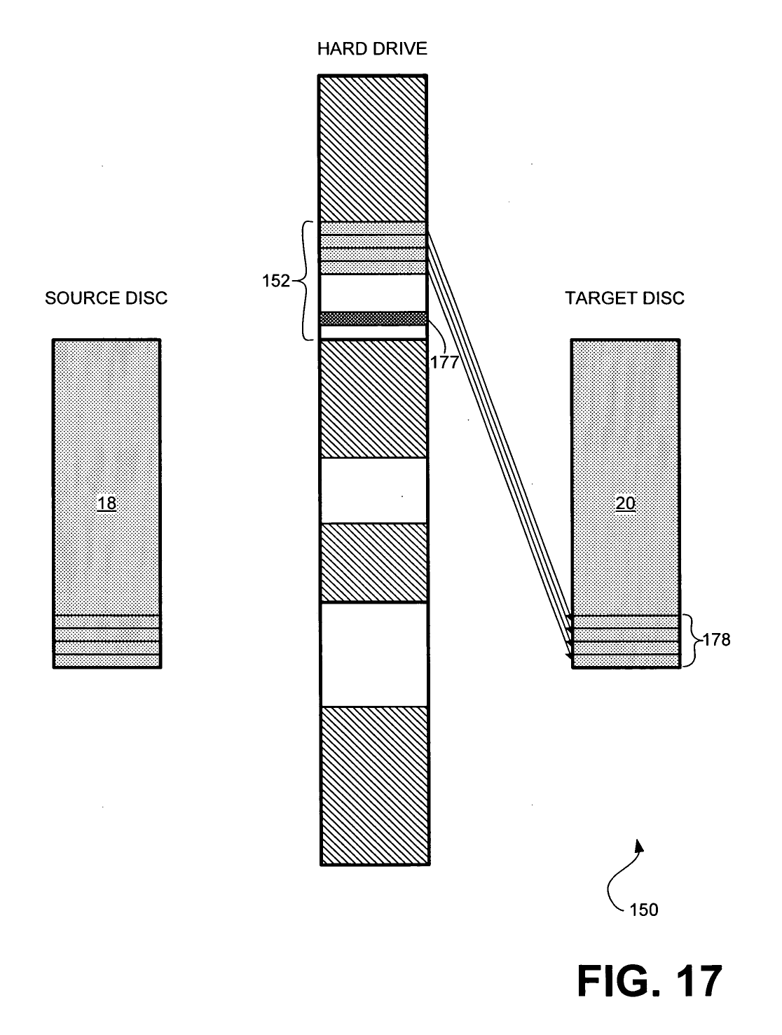

FIG. 17 provides for the copying of the data image files from storage location 152 in partition C of hard drive 14 onto receiving location 178 on target disc 20. As similarly described above, receiving location 178 sequentially or randomly after receiving locations 172, 174, and 176, as shown in FIG. 14. Stated another way, the process 150 places the data image files at storage location 152 at the end of target disc 18 in this nonlimiting example due to the fact that the corresponding data image files are at the end of source disc 18, as shown in FIG. 17. In FIG. 17, the process places the saved image data files towards location 152 at receiving location 178 due to step 136 of FIG. 11 which provides that the target disc saved context information includes the next writing range of target disc 20. Based on this information, the subsequent stages of the copy process can resume at the previous writing point left off in an immediate preceding stage.

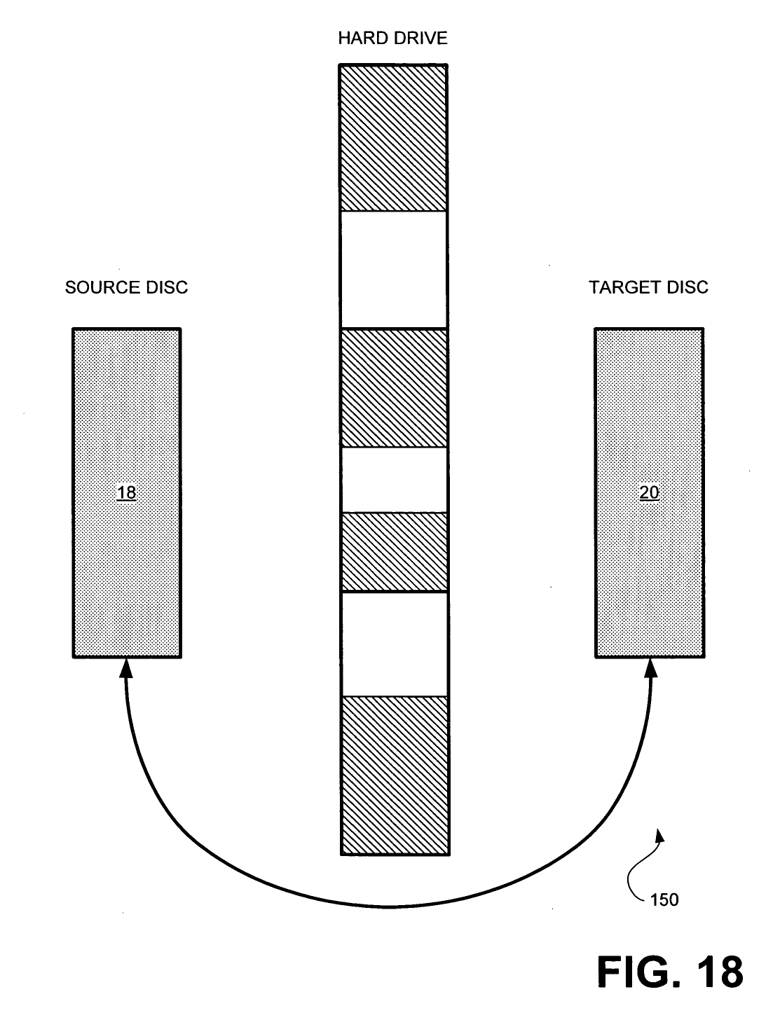

FIG. 18 depicts the conclusion of the process 150, which corresponds to the flowchart 120 of FIG. 11. In this nonlimiting example, the target disc 20 is now an identical copy of the source disc 18, or at least the select files copied from source disc 18, through this multi-stage copy process. As described above, the target disc 20 and source disc 18 were repeatedly exchanged in optical disc drives 16 so that all of the data image files on source disc 18 could be copied onto hard drive 14 and subsequently onto target disc 20 as described above. At the conclusion of the process, any data image files on hard drive 14 may be erased or may be deleted, as shown in FIG. 18.

One of ordinary skill in the art would know that the laptop computer 12 is a computing device having a processor, memory, as one or more peripheral devices, such as optical disc device 16, all coupled by a bus. The processes described herein, such as processes 25, 100, and 120, may be stored in memory as logic executable instructions implemented by the processor, as one of ordinary skill in the art would know.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, having thus described the invention, at least the following is claimed:

1. A method for copying digital data, comprising the steps of:
determining that a collective free storage space on a plurality of hard drive storage partitions is insufficient to contain all of one or more source data files to be copied from a source;
saving a first portion of the one or more source data files to storage space on the plurality of hard drive storage partitions;
writing a copy of the first portion of the source data files saved in the storage space on at least one of the plurality of hard drive storage partitions onto a target storage device;
saving another portion of the one or more source data files to storage space on one or more of the plurality of hard drive storage partitions; and
writing a copy of the another portion of the source data files saved in the storage space on one or more of the plurality of hard drive storage partitions onto the target storage device.

2. The method of claim 1, wherein the writing of the first and the another portions of the source data files are written on the target device sequentially corresponding to an order for which the source data files were copied from the source to the hard drive.

3. The method of claim 1, wherein the writing of the first and the another portions of the source data files are written on the target device in a predetermined order and a file system of the source data files written onto the target device are updated according to the predetermined order.

4. The method of claim 1, further comprising the step of:
removing the copy of the first portion of the source data files saved in the storage space on the plurality of hard drive storage partitions to generate free storage space.

5. The method of claim 1, wherein at least one of the source and the target storage device is a hard drive.

6. The method of claim 1, wherein each of the source and the target storage device is an optical disc.

7. The method of claim 6, wherein each of the source optical disc and target optical disc are interchangeably inserted and ejected from an optical disc device coupled to the hard drive, wherein the optical disc device is configured to read data from the source optical disc when inserted and write data to the target optical disc when inserted.

8. The method of claim 6, further comprising the step of:
saving context information on the hard drive corresponding to a reading range on the source optical disc and a next reading range on the source optical disc upon saving of the one or more source data files on the plurality of hard drive storage partitions.

9. The method of claim 6, further comprising the step of:
saving context information on the hard drive corresponding to status information related to the target optical disc, a writing range for the target optical disc, and a next writing range for the target optical disc upon writing the source data files saved in the storage space on the plurality of hard drive storage partitions onto the target optical disc.

10. The method of claim 1, further comprising the step of:
saving the first portion and the another portion of the source data files on the hard drive in 1 gigabyte increments.

11. The method of claim 1, further comprising the step of:
selecting which of the plurality of hard drive storage partitions to receive the source data files in a predetermined order.

12. The method of claim 1, wherein the plurality of hard drive storage partitions are on a computer hard drive.

13. The method of claim 1, wherein the plurality of hard drive storage partitions are on a plurality of networked hard drives.

14. The method of claim 1, wherein the first portion of the one or more source data files saved on the hard drive consumes all of the available storage space on the plurality of hard drive storage partitions.

15. A system for copying data on a source device to a target device using an intermediary device, comprising:
executable logic configured to determine whether the intermediary device contains sufficient free storage space to store all of the contents of the source device;
executable logic configured to cause a first portion of the contents of the source device to be stored onto a plurality of partitions for the intermediary device;
executable logic configured to cause the first portion of the contents of the source device stored on the plurality of partitions for the intermediary device to be written onto a target device;
executable logic configured to cause one or more additional portions of the contents of the source device to be stored onto one or more additional partitions of the intermediary device after the first portion of the contents of the source device are removed from the intermediary device; and
executable logic configured to cause the one or more additional portions of the contents of the source device stored on the intermediary device to be written onto the target device.

16. The system of claim 15, wherein the contents of the source device stored on the intermediary device are written onto the target device in a sequential order corresponding to an order stored onto the intermediary device.

17. The system of claim 15, wherein the contents of the source device stored on the intermediary device are written onto the target device in a predetermined order, and wherein a file system of the source data files written on the target device are updated according to the predetermined order.

18. The system of claim 15, further comprising:
logic configured to establish a data file that is stored on the intermediary device containing logical location information for each portion of the contents of the source device stored on the intermediary device.

19. The system of claim 15, wherein the intermediary device is a computer hard drive.

20. The system of claim 15, wherein the intermediary device comprises a plurality of storage drives coupled together by a logical network.

21. The system of claim 15, wherein the source device is an optical disc and the source device is an optical disc.

22. The system of claim 21, further comprising:
logic configured to save a source context corresponding to a source optical disc reading range and a source optical disc next reading range after the first portion of the contents of the source device are stored onto the plurality of partitions for the intermediary device.

23. The system of claim 21, further comprising:
logic configured to save a target context corresponding to a target optical disc status, a target optical disc reading range, and a target optical disc next reading range after the first portion of the contents of the source device are written to the target optical disc.

24. The system of claim 21, wherein the source optical disc and the target optical disc are interchangeably inserted and ejected from an optical disc device coupled to the intermediary device.

25. The system of claim 15, wherein the source device is an electronic device having a storage device that may be electronically coupled to the intermediary device.

26. The system of claim 15, further comprising:
logic configured to cause the first portion of the contents of the source device stored on the intermediary device to be removed after being written to the target optical disc.
